(19) United States
(12) Patent Application Publication
(10) Pub. No.: US 2014/0091660 A1
(43) Pub. Date: Apr. 3, 2014

(54) MOTOR

(71) Applicant: SAMSUNG ELECTRO-MECHANICS CO., LTD., Suwon (KR)

(72) Inventor: Viatcheslav Smirnov, Suwon (KR)

(73) Assignee: SAMSUNG ELECTRO-MECHANICS CO., LTD., Suwon (KR)

(21) Appl. No.: 13/693,459

(22) Filed: Dec. 4, 2012

(30) Foreign Application Priority Data
Sep. 28, 2012 (KR) 10-2012-0108742

(51) Int. Cl. H02K 5/16; H02K 7/08

(52) U.S. Cl. CPC H02K 5/165; H02K 7/086
USPC 310/90; 310/425

(57) ABSTRACT

There is provided a motor including: a sleeve rotatably supporting a shaft via a lubricating fluid; a base plate having the sleeve fixed thereto; a stator coupled to the base plate and including a core having a coil wound therearound in order to generate rotational driving force; and a rotor fixed to the shaft to be rotatable with respect to the stator and including a magnet facing the core, wherein the base plate includes a fixing part having the sleeve fixed thereto, an extension part extended from one end of the fixing part in an outer diameter direction, a seating part extended from one end of the extension part upwardly and downwardly in an axial direction, and a body part extended from the seating part in the outer diameter direction.

### CROSS-REFERENCE TO RELATED APPLICATIONS

This application claims the priority of Korean Patent Application No. 10-2012-0108742 filed on Sep. 28, 2012, in the Korean Intellectual Property Office, the disclosure of which is incorporated herein by reference.

### BACKGROUND OF THE INVENTION

1. Field of the Invention

The present invention relates to a motor, and more particularly, to a motor including a base plate formed by press processing.

2. Description of the Related Art

A hard disk drive (HDD), a computer information storage device, reads data stored on a disk or writes data to the disk using a magnetic read-write head.

In this hard disk drive, a base plate is installed with a head driver, that is, a head stack assembly (HSA), capable of moving the magnetic head across the disk. The magnetic head performs its function while moving to a desired position in a state in which it is suspended above a writing surface of the disk by the head driver at a predetermined height.

According to the related art, in manufacturing a base plate provided in the hard disk drive, a post-processing scheme of die-casting aluminum (Al) and then removing burrs or the like, generated due to the die-casting, has been used.

However, in the die-casting scheme according to the related art, since a process of injecting molten state aluminum (Al) into a cast for forging is performed, high degrees of temperature and pressure are required, such that a large amount of energy is required in the process and a process time is increased.

Further, in terms of a lifespan of a die-casting mold, there is a limitation in manufacturing a large number of base plates using a single mold, and a base plate manufactured by the die-casting process has poor dimensional precision.

In addition, a defect in which the base plate is deformed due to a load in an axial direction, an external impact, or the like, may be generated.

Therefore, research into a technology of decreasing the number of manufacturing processes and a manufacturing cost and preventing a base plate from being deformed due to a load in an axial direction, an external impact, or the like, has been demanded.

### [Related Art Document]

### Japanese Patent Laid-Open Publication No. 2007-020241

### SUMMARY OF THE INVENTION

An aspect of the present invention provides a motor capable of decreasing an amount of required manufacturing processes and manufacturing costs, being thinned and miniaturized, and preventing a base plate from being deformed due to a load in an axial direction, external impacts, or the like.

According to an aspect of the present invention, there is provided a motor including: a sleeve rotatably supporting a shaft; a base plate having the sleeve fixed thereto; a stator coupled to the base plate and including a core having a coil wound therearound in order to generate rotational driving force; and a rotor fixed to the shaft to be rotatable with respect to the stator and including a magnet facing the core, wherein the base plate includes a fixing part having the sleeve fixed thereto, an extension part extended from one end of the fixing part in an outer diameter direction, a seating part extended from one end of the extension part upwardly and downwardly in an axial direction, and a body part extended from the seating part in the outer diameter direction.

The base plate may be formed by press processing.

An outer peripheral surface of the fixing part and an inner peripheral surface of the seating part may include a first space part provided therebetween.

An outer peripheral surface of the seating part may be provided with a step part, and the core may be seated on the step part.

The extension part may have a flat upper surface.

An upper end of the seating part in the axial direction may be positioned to be lower than an upper end of the core in the axial direction.

The seating part may include a protrusion part so that an upper end thereof in the axial direction protrudes to be higher than an upper end of the core in the axial direction.

The protrusion part may be bent in the outer diameter direction and coupled to the core.

The motor may be provided to satisfy the following Conditional Equations 1 to 8:

T1≦W1≦5×T1 [Conditional Equation 1]

0.1×T1≦W2≦4×T1 [Conditional Equation 2]

0.3×T1≦W3≦4×T1 [Conditional Equation 3]

T1≦H1≦5×T1 [Conditional Equation 4]

0.1×T1≦H2≦4×T1 [Conditional Equation 5]

0.3×T1≦H3≦4×T1 [Conditional Equation 6]

0.3×T1≦L1≦5×T1 [Conditional Equation 7]

0.1×T1≦R1≦T1 [Conditional Equation 8]

where T1 is a thickness of the base plate, W1 is a distance from an inner peripheral surface of the fixing part to an outer peripheral surface of the seating part, W2 is a distance from an outer peripheral surface of the fixing part to an inner peripheral surface of the seating part, W3 is a distance from the inner peripheral surface of the seating part to the outer peripheral surface of the seating part, H1 is a distance from a lower surface of the base plate to an upper surface of the seating part, H2 is a distance from the lower surface of the base plate to a lower surface of the extension part, H3 is a distance from an upper surface of the extension part to the upper surface of the seating part, L1 is a distance from the inner peripheral surface of the fixing part to the inner peripheral surface of the seating part, and R1 is a radius of curvature of an inner side end of the extension part and an upper end of the seating part provided in a curved surface shape.

The motor may be provided to satisfy the following Conditional Equations 9 to 18:

T1≦W1≦5×T1 [Conditional Equation 9]

0.1×T1≦W2≦4×T1 [Conditional Equation 10]

0.3×T1≦W3≦4×T1 [Conditional Equation 11]

T1≦H1≦5×T1 [Conditional Equation 12]

0.1×T1≦H2≦4×T1 [Conditional Equation 13]

0.3×T1≦H3≦4×T1 [Conditional Equation 14]

0.3×T1≦L1≦5×T1 [Conditional Equation 15]

0.1×T1≦R1≦T1 [Conditional Equation 16]

0.3×W3≦W5≦0.9×W3 [Conditional Equation 17]

0.3×H3≦H5≦0.9×H3 [Conditional Equation 18]

where T1 is a thickness of the base plate, W1 is a distance from an inner peripheral surface of the fixing part to an outer peripheral surface of the seating part, W2 is a distance from an outer peripheral surface of the fixing part to an inner peripheral surface of the seating part, W3 is a distance from the inner peripheral surface of the seating part to the outer peripheral surface of the seating part, H1 is a distance from a lower surface of the base plate to an upper surface of the seating part, H2 is a distance from the lower surface of the base plate to a lower surface of the extension part, H3 is a distance from an upper surface of the extension part to the upper surface of the seating part, L1 is a distance from the inner peripheral surface of the fixing part to the inner peripheral surface of the seating part, R1 is a radius of curvature of an inner side end of the extension part and an upper end of the seating part provided in a curved surface shape, W5 is a distance from an inner peripheral surface of the protrusion part to an outer peripheral surface thereof, and H5 is an axial length of the protrusion part.

The rotor may be provided with a main wall part protruding from one surface thereof so as to face an inner peripheral surface of the seating part.

The main wall part may have a stopper coupled to an inner peripheral surface thereof.

An upper portion of the sleeve may be provided with a flange part protruding in the outer diameter direction.

A portion of an upper surface of the stopper may face a portion of a lower surface of the flange part.

An outer peripheral surface of the sleeve and an inner peripheral surface of the stopper may include a sealing part formed therebetween in order to seal a lubricating fluid.

According to another aspect of the present invention, there is provided a motor including: a sleeve rotatably supporting a shaft; a base plate having the sleeve fixed thereto; a stator coupled to the base plate and including a core having a coil wound therearound in order to generate rotational driving force; and a rotor fixed to the shaft to be rotatable with respect to the stator and including a magnet facing the core, wherein the base plate includes a fixing part having the sleeve fixed thereto, an extension part extended from one end of the fixing part in an outer diameter direction, a seating part having the stator seated thereon, a connection part connecting the extension part and the seating part to each other, and a body part extended from the seating part in the outer diameter direction.

The connection part may have a flat upper surface.

An outer peripheral surface of the extension part and an inner peripheral surface of the seating part may include a second space part provided therebetween.

An upper surface of the connection part may have a curved shape.

An outer peripheral surface of the seating part may be provided with a step part, and the core may be seated on the step part.

The base plate may be formed by press processing.

An outer peripheral surface of the fixing part and an inner peripheral surface of the seating part may include a first space part provided therebetween.

An outer peripheral surface of the extension part and the inner peripheral surface of the seating part may include a second space part provided therebetween.

The rotor may be provided with a main wall part protruding from one surface thereof.

The main wall part may have a stopper coupled to an inner peripheral surface thereof.

An upper portion of the sleeve may be provided with a flange part protruding in the outer diameter direction.

An outer peripheral surface of the sleeve and an inner peripheral surface of the stopper may include a sealing part formed therebetween in order to seal a lubricating fluid.

The motor may be provided to satisfy the following Conditional Equations 19 to 28:

T1≦W1≦5×T1 [Conditional Equation 19]

0.1×T1≦W2≦4×T1 [Conditional Equation 20]

0.3×T1≦W3≦4×T1 [Conditional Equation 21]

T1≦H1≦5×T1 [Conditional Equation 22]

0.1×T1≦H2≦4×T1 [Conditional Equation 23]

0.3×T1≦H3≦4×T1 [Conditional Equation 24]

0.3×T1≦L1≦5×T1 [Conditional Equation 25]

0.1×T1≦R1≦T1 [Conditional Equation 26]

0.1×T1≦W4≦3×T1 [Conditional Equation 27]

0.1×T1≦H4≦4×T1 [Conditional Equation 28]

where T1 is a thickness of the base plate, W1 is a distance from an inner peripheral surface of the fixing part to an outer peripheral surface of the seating part, W2 is a distance from an outer peripheral surface of the fixing part to an inner peripheral surface of the seating part, W3 is a distance from the inner peripheral surface of the seating part to the outer peripheral surface of the seating part, Hl is a distance from a lower surface of the base plate to an upper surface of the seating part, H2 is a distance from the lower surface of the base plate to a lower surface of the extension part, H3 is a distance from an upper surface of the extension part to the upper surface of the seating part, L1 is a distance from the inner peripheral surface of the fixing part to the inner peripheral surface of the seating part, R1 is a radius of curvature of an inner side end of the extension part and an upper end of the seating part provided in a curved surface shape, W4 is a distance from an outer peripheral surface of the extension part to the inner peripheral surface of the seating part, and H4 is a distance from the lower surface of the extension part to the upper surface thereof.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view of a motor according to a first embodiment of the present invention;

FIG. 2A is a schematic cross-sectional view of a stator according to the first embodiment of the present invention;

FIG. 2B is a schematic cross-sectional view of the stator according to the first embodiment of the present invention;

FIG. 3 is a perspective view of a base plate according to the first embodiment of the present invention;

FIG. 4A is a schematic cross-sectional view of a stator according to a second embodiment of the present invention;

FIG. 4B is a schematic cross-sectional view of the stator according to the second embodiment of the present invention;

FIG. 5A is a schematic cross-sectional view of a stator according to a third embodiment of the present invention;

FIG. 5B is a schematic cross-sectional view of the stator according to the third embodiment of the present invention;

FIG. 6 is a schematic cross-sectional view of a motor according to a fourth embodiment of the present invention;

FIG. 7A is a schematic cross-sectional view of a stator according to the fourth embodiment of the present invention;

FIG. 7B is a schematic cross-sectional view of the stator according to the fourth embodiment of the present invention;

FIG. 8 is a perspective view of a base plate according to the fourth embodiment of the present invention;

FIG. 9A is a schematic cross-sectional view of a stator according to a fifth embodiment of the present invention;

FIG. 9B is a schematic cross-sectional view of the stator according to the fifth embodiment of the present invention;

FIG. 10 is a perspective view of a base plate according to the fifth embodiment of the present invention;

FIG. 11 is a comparative graph showing a deformation degree of the base plate in an axial direction;

FIG. 12 is a comparative graph showing a deformation degree of a curvature radius (R1);

FIG. 13 is a comparative graph of stress (MPa);

FIG. 14 is a comparative graph of a strength improvement rate of the stator; and

FIG. 15 is a comparative table showing results of the graphs of FIGS. 11 through 14.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements maybe exaggerated for clarity, and the same reference numerals will be used throughout to designate the same or like elements.

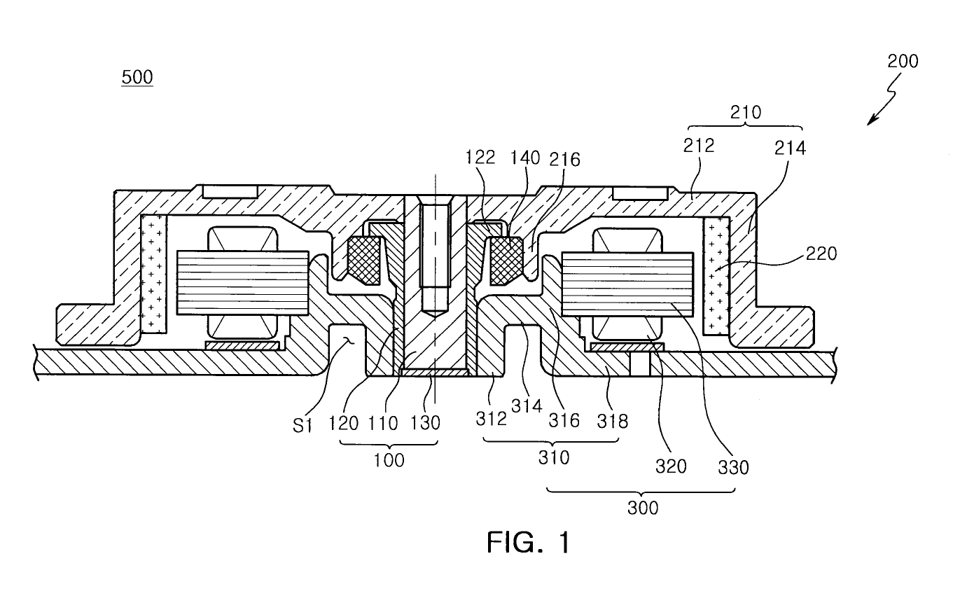

FIG. 1 is a schematic cross-sectional view of a motor according to a first embodiment of the present invention.

Referring to FIG. 1, a motor 500 according to an embodiment of the present invention may include a hydrodynamic bearing assembly 100, a stator 300, and a rotor 200.

Terms with respect to directions will first be defined. As viewed in FIG. 1, an axial direction refers to a vertical direction based on the shaft 110, and an outer diameter direction or an inner diameter direction refers to a direction towards an outer edge of the rotor 200 based on the shaft 110 or a direction towards the center of the shaft 110 based on the outer edge of the rotor 200.

The hydrodynamic bearing assembly 100 may include a shaft 110, a sleeve 120, and a cover plate 130.

The sleeve 120 may support the shaft 110 so that an upper end of the shaft 110 protrudes upwardly in the axial direction and be formed by forging Cu or Al or sintering Cu-Fe based alloy powders or SUS based powders.

In this configuration, the shaft 110 may be inserted into a shaft hole of the sleeve 120 so as to have a micro clearance between the shaft hole of the sleeve 120 and the shaft 110. The micro clearance may be filled with a lubricating fluid, and the rotation of the shaft 110 may be more smoothly supported by a radial dynamic pressure groove (not shown) formed in at least one of an outer diameter of the shaft 110 and an inner diameter of the sleeve 120.

The radial dynamic pressure groove (not shown) may be formed in an inner peripheral surface of the sleeve 120, which is an inner portion of the shaft hole of the sleeve 120, and generate fluid dynamic pressure so that the shaft 110 may smoothly rotate in a state in which the shaft 110 is spaced apart from the inner peripheral surface of the sleeve 120 by a predetermined interval.

However, the radial dynamic pressure groove (not shown) is not limited to being formed in the inner peripheral surface of the sleeve 120 as described above, but may also be formed in an outer peripheral surface of the shaft 110. In addition, the number of radial dynamic pressure grooves (not shown) is not limited.

Here, the radial dynamic pressure groove (not shown) may have at least one of a herringbone shape, a spiral shape, and a helical shape. However, the radial dynamic pressure groove may have any shape as long as radial dynamic pressure may be generated thereby.

In addition, a thrust dynamic pressure groove (not shown) maybe formed in at least one of an upper surface of the sleeve 120 and one surface of the rotor 200 facing the upper surface of the sleeve 120. The rotor 200 may rotate together with the shaft 110 in a state in which it secures a predetermined amount of floating force by the thrust dynamic pressure groove (not shown).

Here, the thrust dynamic pressure groove (not shown) may be a groove having a herringbone shape, a spiral shape, or a helical shape, similar to the radial dynamic pressure groove (not shown). However, the thrust dynamic pressure groove (not shown) is not limited to having the above-mentioned shape, but may have any shape as long as thrust dynamic pressure may be provided thereby.

The cover plate 130 may be coupled to the sleeve 120 in a state in which it maintains a clearance with a lower portion of the shaft 110.

The cover plate 130 may receive the lubricating fluid in the clearance formed between the cover plate 130 and the shaft 110 to serve as a bearing supporting a lower surface of the shaft 110.

Here, as a method of fixing the cover plate 130, there may be provided several methods such as a welding method, a caulking method, a bonding method, or the like, which may be selectively applied according to a structure and a process of a product.

The stator 300 may include a coil 320, a core 330, and a base plate 310.

The stator 300 may be a fixed structure including the core 330 having the coil 320 wound therearound, wherein the coil 320 generates electromagnetic force having a predetermined magnitude at the time of applying power.

The core 330 may be fixedly disposed on an upper portion of the base plate 310 provided with a printed circuit board (not shown) having pattern circuits printed thereon, and a plurality of coil holes having a predetermined size may be formed to penetrate a portion of the base plate 310 so as to correspond to the core 330 around which the coil 320 is wound, such that one end of the coil 320 is exposed downwardly and the coil 320 may be electrically connected to the printed circuit board (not shown) in order to be supplied with external power thereto.

The rotor 200 may be a rotating structure rotatably provided with respect to the stator 300 and may include a rotor case 210 having an annular ring shaped magnet 220 provided on an inner peripheral surface thereof, wherein the annular ring shaped magnet 220 corresponds to the core 330, having a predetermined interval therebetween.

Here, the rotor case 210 may include a hub base 212 press-fitted onto and fixed to the upper end of the shaft 110 and a magnet support part 214 extended from the hub base 212 in an outer diameter direction and bent downwardly in the axial direction to support the magnet 220.

In addition, as the magnet 220, a permanent magnet generating magnetic force having a predetermined strength by alternately magnetizing an N pole and an S pole thereof in a circumferential direction may be used.

Rotational driving of the rotor 200 will be schematically described hereinafter. When power is supplied to the coil 320 wound around the core 330, driving force capable of rotating the rotor 200 may be generated by electromagnetic interaction between the magnet 220 and the core 330 having the coil 320 wound therearound.

Therefore, the rotor 200 rotates, such that shaft 110 to which the rotor 200 is fixedly coupled may rotate together with the rotor 200.

The rotor 200 may be provided with a main wall part 216 protruding from one surface thereof in the downward axial direction.

The main wall part 216 may have a stopper 140 coupled to an inner peripheral surface thereof, and an inner peripheral surface of the stopper 140 and an outer peripheral surface of the sleeve 120 may have a sealing part formed therebetween in order to seal the lubricating fluid.

That is, the main wall part 216 may protrude from one surface of the rotor 200, a rotating member, to fix the stopper 140 provided with an inner circumferential surface thereof, and the lubricating fluid may be sealed between the stopper 140 and the sleeve 120, a fixed member.

The outer peripheral surface of the sleeve 120 corresponding to the inner peripheral surface of the stopper 140 may be tapered so that the lubricating fluid is sealed.

Here, an upper portion of the sleeve 120 may be provided with a flange part 122 protruding in the outer diameter direction, and a lower surface of the flange part 122 may face a portion of an upper surface of the stopper 140.

Therefore, in the case in which the shaft 110 and the rotor 200, which are rotating members, are excessively floated, a portion of the upper surface of the stopper 140 is caught by the lower surface of the flange part 122, whereby the excessive floating of the rotating member may be prevented.

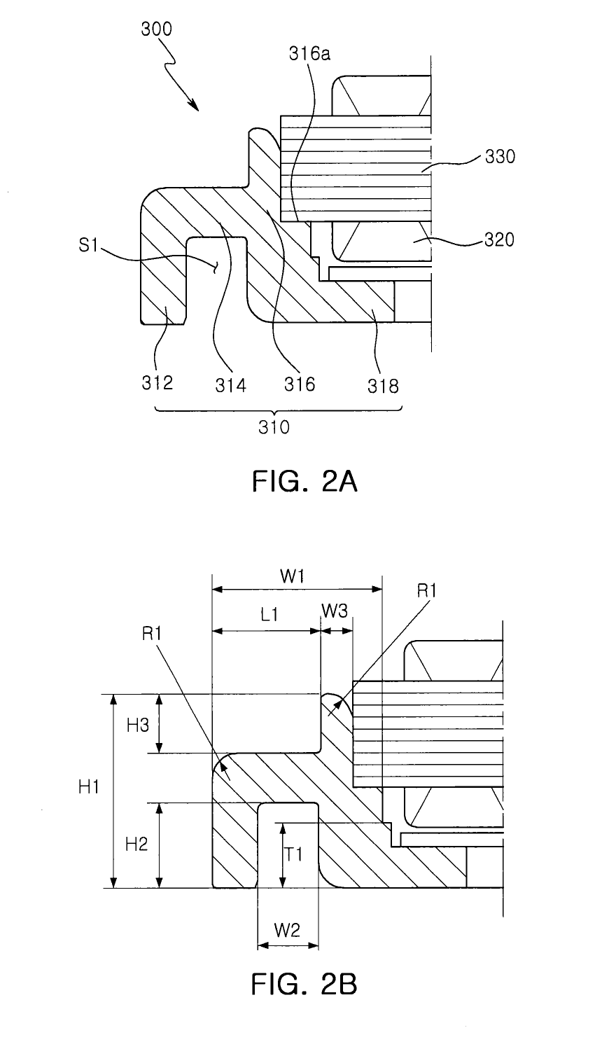

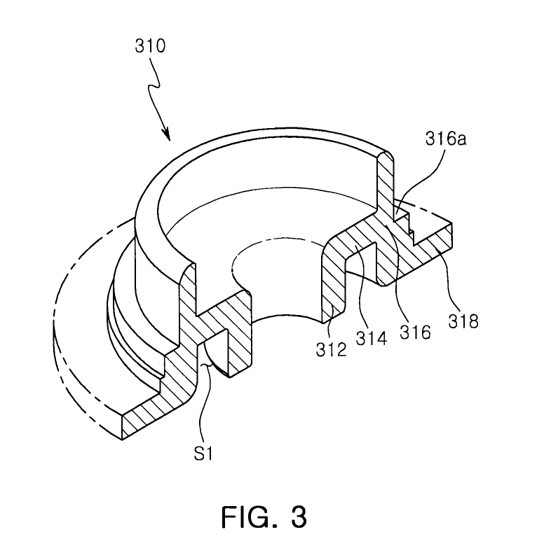

FIGS. 2A and 2B are schematic cross-sectional views of a stator according to the first embodiment of the present invention; and FIG. 3 is a perspective view of a base plate according to the first embodiment of the present invention.

Referring to FIGS. 2A through 3, the base plate 310 according to the first embodiment of the present invention may include a fixing part 312, an extension part 314, a seating part 316, and a body part 318.

The fixing part 312 may have the sleeve 120 fixed thereto, the extension part 314 may be extended from one end of the fixing part 312 in the outer diameter direction, the seating part 316 may be extended from one end of the extension part 314 upwardly and downwardly in an axial direction, and the body part 318 may be extended from the seating part 316 in the outer diameter direction.

Here, the base plate 310 may be manufactured by performing plastic working such as press processing, or the like, on a cold rolled steel sheet (SPCC, SPCE, or the like), a hot rolled steel sheet, a stainless steel, or a lightweight alloy steel sheet formed of an alloy such as a boron or magnesium alloy.

More specifically, the sleeve 120 may be inserted into an inner peripheral surface of the fixing part 312, and the inner peripheral surface of the fixing part 312 and an outer peripheral surface of the sleeve 120 may be coupled to each other by at least one of a sliding method, an adhesion method, a welding method, and a press-fitting method.

The extension part 314 may be extended from one end of the fixing part 312 in the outer diameter direction and have a flat upper surface.

The seating part 316 may be extended from one end of the extension part 314 in the upward and downward axial directions and have a step part 316a provided on an outer peripheral surface thereof, wherein the step part 316a may have the core 330 seated thereon and fixed thereto.

Here, an upper end of the seating part 316 may be positioned to be lower than an upper end of the core 330 in the axial direction provided in the stator 300.

Here, an inner side end of the extension part 314 and the upper end of the seating part 316 may have a curved shape having a radius of curvature of R1.

In addition, an inner peripheral surface of the seating part 316 extended from the extension part 314 in the upward axial direction may face an outer peripheral surface of the main wall part 216.

Since the fixing part 312 and the seating part 316 are connected to each other by the extension part 314, an empty space may be provided among the fixing part 312, the seating part 316, and the extension part 314 in a state in which one side thereof is opened.

That is, a first space part S1 may be provided between an outer peripheral surface of the fixing part 312 and the inner peripheral surface of the seating part 316.

T1, W1, W2, W3, H1, H2, H3, L1, and R1 will be defined as follows with reference to FIG. 2B.

T1 is a thickness of the base plate, W1 is a distance from the inner peripheral surface of the fixing part to the outer peripheral surface of the seating part, W2 is a distance from the outer peripheral surface of the fixing part to the inner peripheral surface of the seating part, W3 is a distance from the inner peripheral surface of the seating part to the outer peripheral surface of the seating part, H1 is a distance from a lower surface of the base plate to an upper surface of the seating part, H2 is a distance from the lower surface of the base plate to a lower surface of the extension part, H3 is a distance from the upper surface of the extension part to the upper surface of the seating part, L1 is a distance from the inner peripheral surface of the fixing part to the inner peripheral surface of the seating part, and R1 is a radius of curvature of the inner side end of the extension part and the upper end of the seating part provided in a curved surface shape.

Here, the motor 500 according to the first embodiment of the present invention may satisfy the following Conditional Equations 1 to 8.

T1≦W1≦5×T1 [Conditional Equation 1]

0.1×T1≦W2≦4×T1 [Conditional Equation 2]

0.3×T1≦W3≦4×T1 [Conditional Equation 3]

T1≦H1≦5×T1 [Conditional Equation 4]

0.1×T1≦H2≦4×T1 [Conditional Equation 5]

0.3×T1≦H3≦4×T1 [Conditional Equation 6]

0.3×T1≦L1≦5×T1 [Conditional Equation 7]

0.1×T1≦R1≦T1 [Conditional Equation 8]

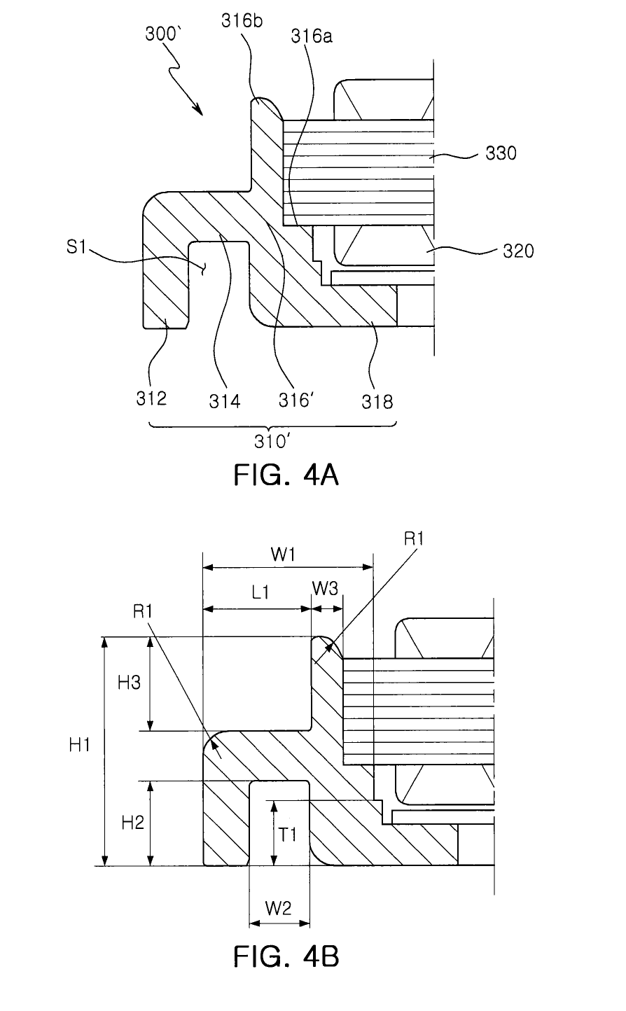

FIGS. 4A and 4B are schematic cross-sectional views of a stator according to a second embodiment of the present invention.

Referring to FIGS . 4A and 4B, a base plate 310′ according to the second embodiment of the present invention is the same as the base plate 310 according to the first embodiment of the present invention except for a seating part 316′. Therefore, a description of components except for the seating part 316′ will be omitted.

The base plate 310′ according to the second embodiment of the present invention may include a fixing part 312 having the sleeve 120 fixed thereto, an extension part 314 extended from one end of the fixing part 312 in the outer diameter direction, the seating part 316′ extended from one end of the extension part 314 in the upward and downward axial directions, and a body part 318 extended from the seating part 316′ in the outer diameter direction.

Here, an upper end of the seating part 316′ extended in the upward axial direction may be provided with a protrusion part 316b protruding to be higher than an axial upper end of the core 330 provided in the stator 300′.

Since a contact area between the core 330 and the seating part 316′ increases, coupling force between the core 330 and the base plate 310′ may be improved.

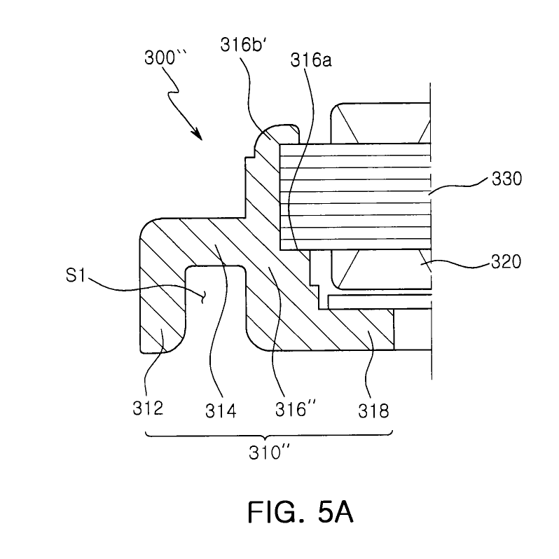

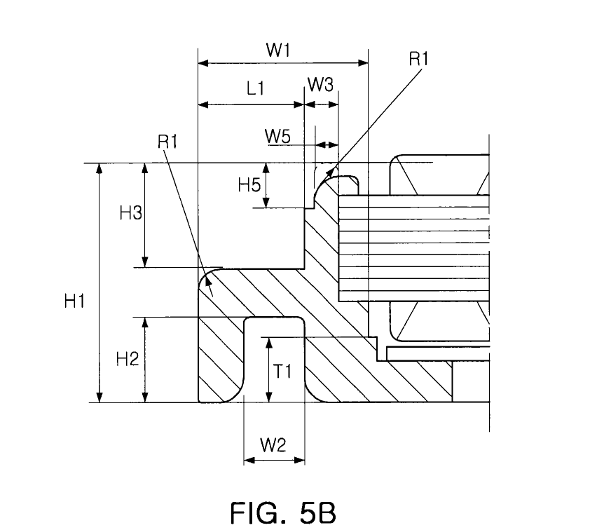

FIGS. 5A and 5B are schematic cross-sectional views of a stator according to a third embodiment of the present invention.

Referring to FIGS . 5A and 5B, a base plate 310″ according to the third embodiment of the present invention is the same as the base plate 310 according to the first embodiment of the present invention except for a seating part 316″. Therefore, a description of components except for the seating part 316″ will be omitted.

The base plate 310″ according to the third embodiment of the present invention may include a fixing part 312 having the sleeve 120 fixed thereto, an extension part 314 extended from one end of the fixing part 312 in the outer diameter direction, the seating part 316″ extended from one end of the extension part 314 in the upward and downward axial directions, and a body part 318 extended from the seating part 316″ in the outer diameter direction.

Here, an upper end of the seating part 316″ extended in the upward axial direction may be provided with a protrusion part 316b′ protruding to be higher than an upper axial end of the core 330 provided in the stator 300″.

Here, an inner peripheral surface of the protrusion part 316b′ and an inner peripheral surface of the seating part 316″ may have a step formed therebetween.

That is, a distance from the inner peripheral surface of the protrusion part 316b′ to an outer peripheral surface thereof may be smaller than a distance from the inner peripheral surface of the seating part 316″ to an outer peripheral surface thereof.

The protrusion part 316b′ may be bent in the outer diameter direction and be coupled to the upper surface of the core 330.

Since a contact area between the core 330 and the seating part 316″ increases and a portion of the upper surface of the core 330 and a portion of the lower surface of the core 330 are seated on the seating part 316″, unmating force of the core 330 may be improved.

T1, W1, W2, W3, H1, H2, H3, L1, R1, W5, and H5 will be defined as follows with reference to FIG. 5B.

T1 is a thickness of the base plate, W1 is a distance from the inner peripheral surface of the fixing part to the outer peripheral surface of the seating part, W2 is a distance from the outer peripheral surface of the fixing part to the inner peripheral surface of the seating part, W3 is a distance from the inner peripheral surface of the seating part to the outer peripheral surface of the seating part, H1 is a distance from a lower surface of the base plate to an upper surface of the seating part, H2 is a distance from the lower surface of the base plate to a lower surface of the extension part, H3 is a distance from the upper surface of the extension part to the upper surface of the seating part, L1 is a distance from the inner peripheral surface of the fixing part to the inner peripheral surface of the seating part, R1 is a radius of curvature of the inner side end of the extension part and the upper end of the seating part provided in a curved surface shape, W5 is a distance from an inner peripheral surface of the protrusion part to an outer peripheral surface thereof, and H5 is an axial length of the protrusion part.

Here, the motor according to the third embodiment of the present invention may satisfy the following Conditional Equations 9 to 18.

T1≦W1≦5×T1 [Conditional Equation 9]

0.1×T1≦W2≦4×T1 [Conditional Equation 10]

0.3×T1≦W3≦4×T1 [Conditional Equation 11]

T1≦H1≦5×T1 [Conditional Equation 12]

0.1×T1≦H2≦4×T1 [Conditional Equation 13]

0.3×T1≦H3≦4×T1 [Conditional Equation 14]

0.3×T1≦L1≦5×T1 [Conditional Equation 15]

0.1×T1≦R1≦T1 [Conditional Equation 16]

0.3×W3≦W5≦0.9×W3 [Conditional Equation 17]

0.3×H3≦H5≦0.9×H3 [Conditional Equation 18]

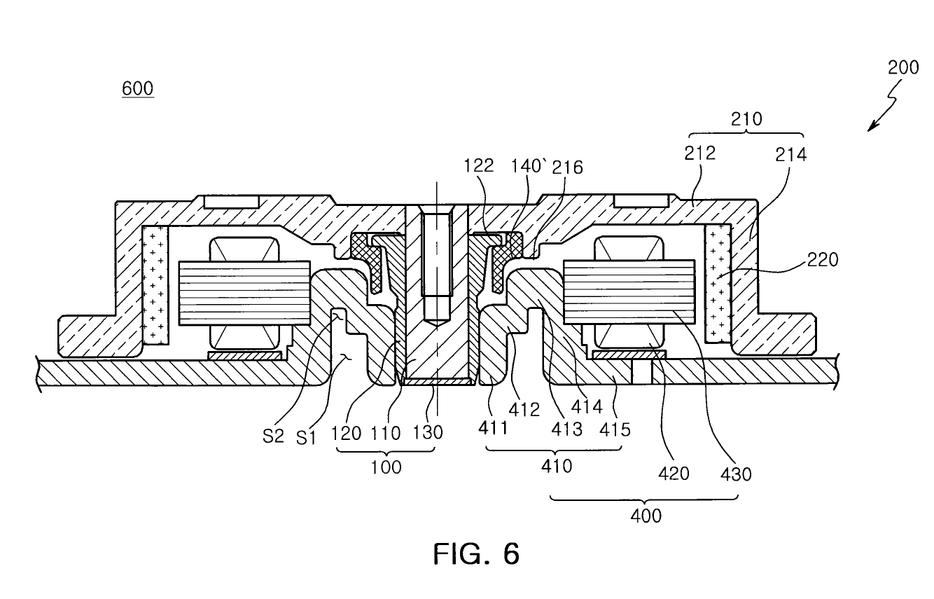

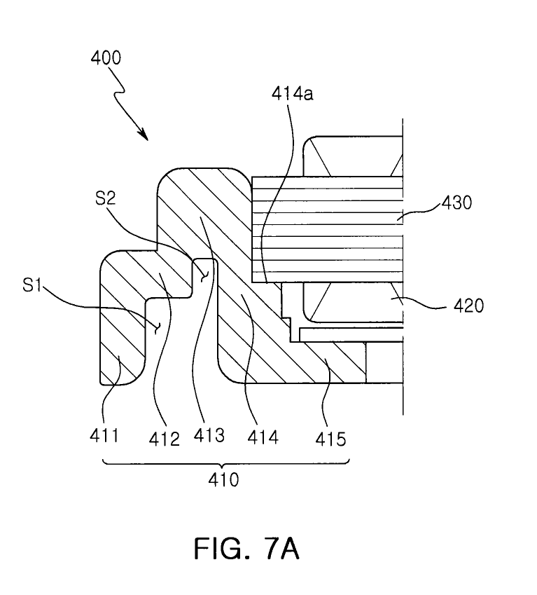

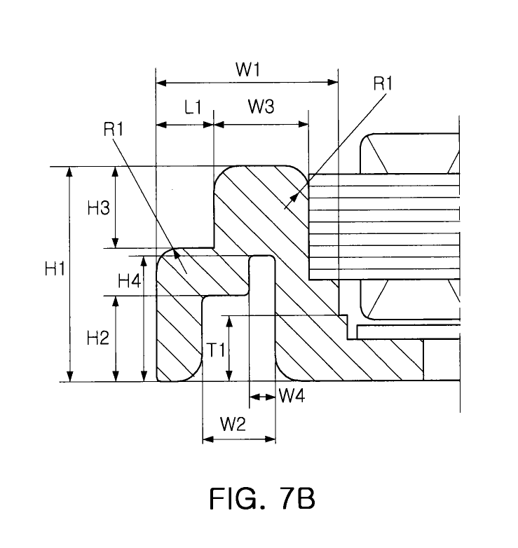

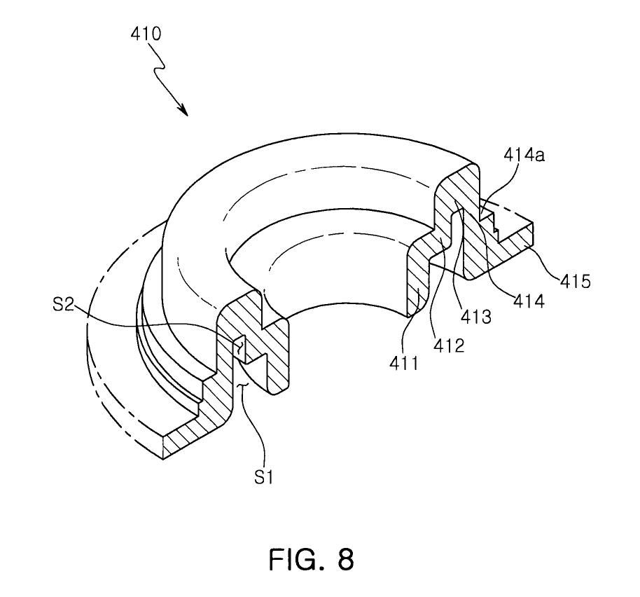

FIG. 6 is a schematic cross-sectional view of a motor according to a fourth embodiment of the present invention; FIGS. 7A and 7B are schematic cross-sectional views of a stator according to the fourth embodiment of the present invention; and FIG. 8 is a perspective view of a base plate according to the fourth embodiment of the present invention.

Referring to FIGS. 6 through 8, the base plate 410 according to the fourth embodiment of the present invention is the same as the base plate 310 according to the first embodiment of the present invention except for a connection part 413 and a second space part S2. Therefore, a description of components except for the connection part 413 and the second space part S2 will be omitted.

The base plate 410 according to the fourth embodiment of the present invention may include a fixing part 411 having the sleeve 120 fixed thereto, an extension part 412 extended from one end of the fixing part 411 in the outer diameter direction, a seating part 414 having the core 430 seated thereon, the connection part 413 connecting the extension part 412 and the seating part 414 to each other, and a body part 415 extended from the seating part 414 in the outer diameter direction.

The connection part 413 may be a component connecting the extension part 412 and the seating part 414 to each other and have a flat upper surface.

The base plate 410 according to the fourth embodiment of the present invention may be provided with a first space part S1 formed to be enclosed by the fixing part 411, the extension part 412 and the seating part 414, and be provided with a second space part S2 formed to be enclosed by the extension part 412, the connection part 413 and the seating part 414.

That is, the second space part S1 may be formed between an outer peripheral surface of the extension part 412 and an inner peripheral surface of the seating part 414.

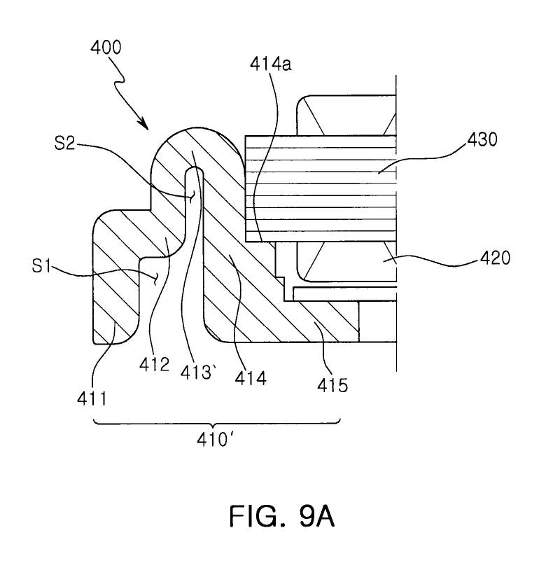

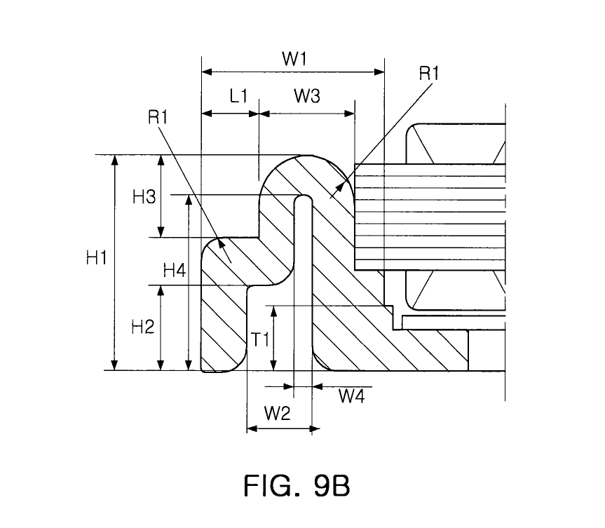

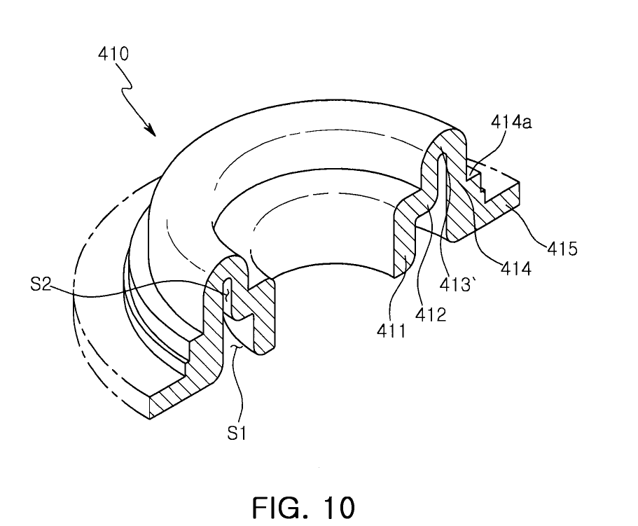

FIGS. 9A and 9B are schematic cross-sectional views of a stator according to a fifth embodiment of the present invention; and FIG. 10 is a perspective view of a base plate according to the fifth embodiment of the present invention.

Referring to FIGS. 9A and 10, a base plate 410′ according to the fifth embodiment of the present invention is the same as the base plate 410 according to the fourth embodiment of the present invention except for a connection part 413′. Therefore, a description of components except for the connection part 413′ will be omitted.

The base plate 410′ according to the fifth embodiment of the present invention may include a fixing part 411 having the sleeve 120 fixed thereto, an extension part 412 extended from one end of the fixing part 411 in the outer diameter direction, a seating part 414 having the core 430 seated thereon, the connection part 413′ connecting the extension part 412 and the seating part 414 to each other, and a body part 415 extended from the seating part 414 in the outer diameter direction.

Here, an upper surface of the connection part 413′ may have a curved shape having a radius of curvature of R1.

T1, W1, W2, W3, H1, H2, H3, L1, R1, W4, and H4 will be defined as follows with reference to FIGS. 7B and 9B.

T1 is a thickness of the base plate, W1 is a distance from the inner peripheral surface of the fixing part to the outer peripheral surface of the seating part, W2 is a distance from the outer peripheral surface of the fixing part to the inner peripheral surface of the seating part, W3 is a distance from the inner peripheral surface of the seating part to the outer peripheral surface of the seating part, H1 is a distance from a lower surface of the base plate to an upper surface of the seating part, H2 is a distance from the lower surface of the base plate to a lower surface of the extension part, H3 is a distance from the upper surface of the extension part to the upper surface of the seating part, L1 is a distance from the inner peripheral surface of the fixing part to the inner peripheral surface of the seating part, R1 is a radius of curvature of the inner side end of the extension part and the upper end of the seating part provided in a curved surface shape, W4 is a distance from an outer peripheral surface of the extension part to the inner peripheral surface of the seating part, and H4 is a distance from the lower surface of the extension part to the upper surface thereof.

Here, the motor according to the fourth and fifth embodiments of the present invention may satisfy the following Conditional Equations 19 to 28.

T1≦W1≦5×T1 [Conditional Equation 19]

0.1×T1≦W2≦4×T1 [Conditional Equation 20]

0.3×T1≦W3≦4×T1 [Conditional Equation 21]

T1≦H1≦5×T1 [Conditional Equation 22]

0.1×T1≦H2≦4×T1 [Conditional Equation 23]

0.3×T1≦H3≦4×T1 [Conditional Equation 24]

0.3×T1≦L1≦5×T1 [Conditional Equation 25]

0.1×T1≦R1≦T1 [Conditional Equation 26]

0.1×T1≦W4≦3×T1 [Conditional Equation 27]

0.1×T1≦H4≦4×T1 [Conditional Equation 28]

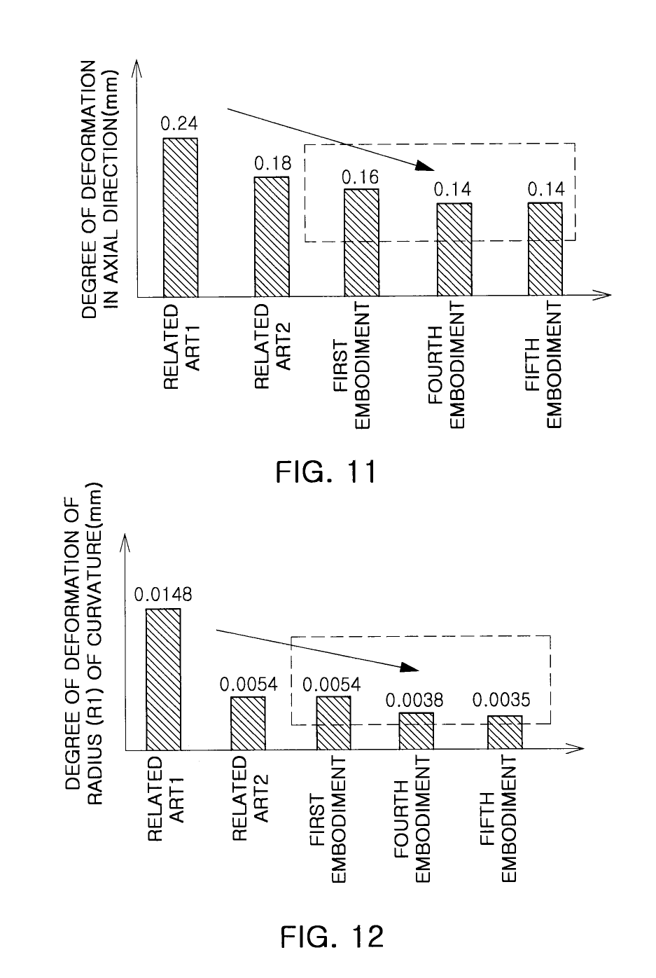

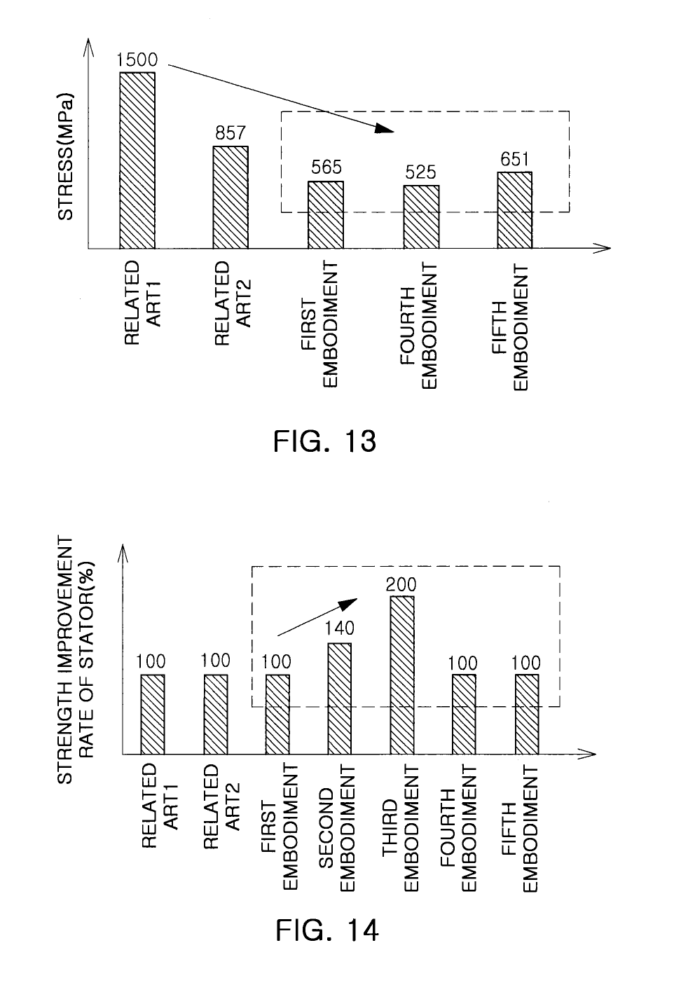

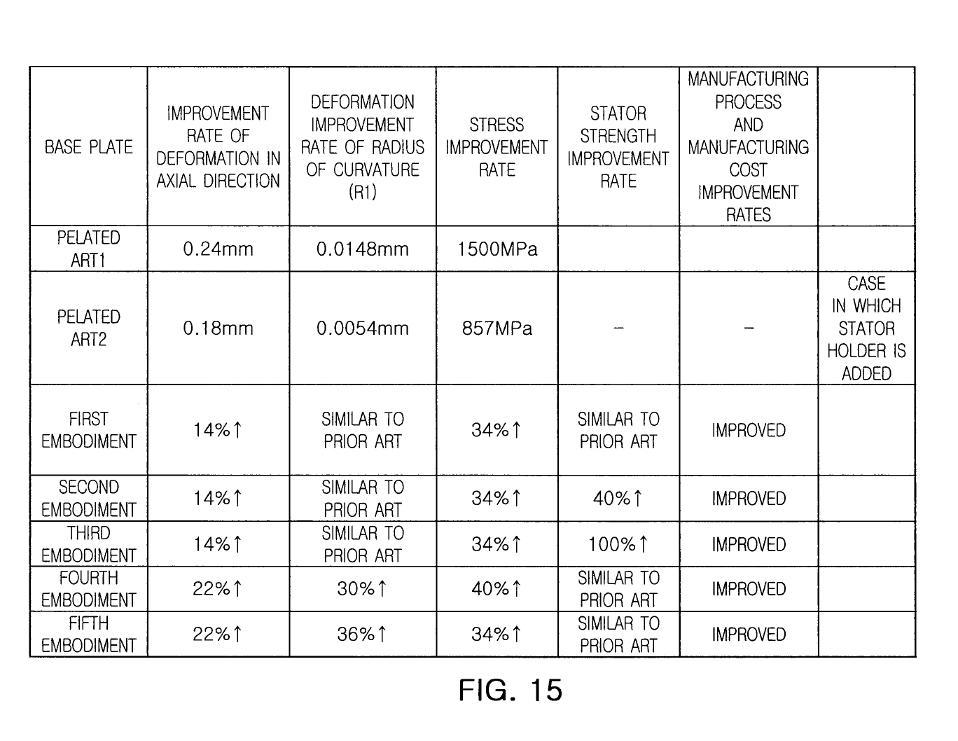

FIG. 11 is a comparative graph showing a deformation degree of the base plate in an axial direction; FIG. 12 is a comparative graph showing a deformation degree of a curvature radius (R1); FIG. 13 is a comparative graph of stress (MPa); and FIG. 14 is a comparative graph of a strength improvement rate of the stator.

Here, related art 1 represents a base plate manufactured by a die-casting method, and related art 2 represents a structure in which a base plate is manufactured by a die-casting method and a stator holder is additionally coupled to the base plate to fix a stator.

Referring to FIGS. 11 and 12, in the case in which a load in an axial direction, an external impact, or the like, is applied to the motor in the axial direction, deformation degrees of the motor according to the related art and the motor according to the embodiments of the present invention may be compared with each other.

In the case of related art 1, the deformation degree in the axial direction is the largest, and in the case of related art 2, the stator holder is added, such that the deformation degree in the axial direction is smaller as compared with related art 1.

Further, in the case of related art 1, the deformation degree of the radius of curvature of the base plate is the largest, and in the case of related art 2, the stator holder is added, such that the deformation degree of the radius of curvature of the base plate is improved as compared to related art 1.

In the case of the motors according to the first embodiment, the fourth embodiment, and the fifth embodiment of the present invention, the generation of the deformation in the axial direction and the deformation of the radius of curvature of the base plate may be decreased without separately adding the stator holder as in the related art 2.

That is, since the base plate according to the embodiments of the present invention is manufactured by performing press processing on an iron-based steel sheet or an alloy, rigidity may be improved. In addition, even in the case that load in the axial direction or an external impact is applied to the base plate, since the base plate may be supported by the fixing part, the seating part, the connection part, and the extension part, the deformation of the base plate may be prevented.

Referring to FIG. 13, the motor according to the related art and the motor according to the embodiments of the present invention may be compared with each other, with respect to force (stress) acting per unit area, generating the deformation in the base plate.

In the case of the related art 2, since the stator holder is separately added, the force acting per unit area may be dispersed, whereby the stress may be smaller as compared with the case of related art 1.

In the case of the motors according to the first embodiment, the fourth embodiment, and the fifth embodiment of the present invention, the force acting on the base plate per unit area may be decreased without separately adding the stator holder as in the related art 2.

Referring to FIG. 14, strength improvement rates of the stator may be compared with each other.

In the case of the second and third embodiments of the present invention, since the contact area between the base plate and the stator is increased, the coupling force therebetween may be increased. Therefore, the strength of the stator may be improved.

As set forth above, with the motor according to the embodiments of the present invention, the number of manufacturing processes and manufacturing costs of the motor may be decreased, the motor may be thinned and miniaturized, and deformation of the base plate of the motor due to load in an axial direction, an external impact, or the like may be prevented.

Further, the base plate is manufactured by the press processing to significantly decrease the process time and the energy consumption, whereby the production capability may be improved.

While the present invention has been shown and described in connection with the embodiments, it will be apparent to those skilled in the art that modifications and variations can be made without departing from the spirit and scope of the invention as defined by the appended claims.

What is claimed is:

1. A motor comprising:
a sleeve rotatably supporting a shaft;
a base plate having the sleeve fixed thereto;
a stator coupled to the base plate and including a core having a coil wound therearound in order to generate rotational driving force; and
a rotor fixed to the shaft to be rotatable with respect to the stator and including a magnet facing the core,
the base plate including a fixing part having the sleeve fixed thereto, an extension part extended from one end of the fixing part in an outer diameter direction, a seating part extended from one end of the extension part upwardly and downwardly in an axial direction, and a body part extended from the seating part in the outer diameter direction.

2. The motor of claim 1, wherein the base plate is formed by performing plastic deformation on a steel sheet.

3. The motor of claim 1, wherein an outer peripheral surface of the fixing part and an inner peripheral surface of the seating part include a first space part provided therebetween.

4. The motor of claim 1, wherein an outer peripheral surface of the seating part is provided with a step part, and the core is seated on the step part.

5. The motor of claim 1, wherein the extension part has a flat upper surface.

6. The motor of claim 1, wherein an upper end of the seating part in the axial direction is positioned to be lower than an upper end of the core in the axial direction.

7. The motor of claim 1, wherein the seating part includes a protrusion part so that an upper end thereof in the axial direction protrudes to be higher than an upper end of the core in the axial direction.

8. The motor of claim 7, wherein the protrusion part is bent in the outer diameter direction and coupled to the core.

9. The motor of claim 1, wherein the motor is provided to satisfy the following Conditional Equations 1 to 8:
T1≦W1≦5×T1 [Conditional Equation 1]
0.1×T1≦W2≦4×T1 [Conditional Equation 2]
0.3×T1≦W3≦4×T1 [Conditional Equation 3]
T1≦H1≦5×T1 [Conditional Equation 4]
0.1×T1≦H2≦4×T1 [Conditional Equation 5]
0.3×T1≦H3≦4×T1 [Conditional Equation 6]
0.3×T1≦L1≦5×T1 [Conditional Equation 7]
0.1×T1≦R1≦T1 [Conditional Equation 8]
where T1 is a thickness of the base plate, W1 is a distance from an inner peripheral surface of the fixing part to an outer peripheral surface of the seating part, W2 is a distance from an outer peripheral surface of the fixing part to an inner peripheral surface of the seating part, W3 is a distance from the inner peripheral surface of the seating part to the outer peripheral surface of the seating part, H1 is a distance from a lower surface of the base plate to an upper surface of the seating part, H2 is a distance from the lower surface of the base plate to a lower surface of the extension part, H3 is a distance from an upper surface of the extension part to the upper surface of the seating part, L1 is a distance from the inner peripheral surface of the fixing part to the inner peripheral surface of the seating part, and R1 is a radius of curvature of an inner side end of the extension part and an upper end of the seating part provided in a curved surface shape.

10. The motor of claim 8, wherein the motor is provided to satisfy the following Conditional Equations 9 to 18:
T1≦W1≦5×T1 [Conditional Equation 9]
0.1×T1≦W2≦4×T1 [Conditional Equation 10]
0.3×T1≦W3≦4×T1 [Conditional Equation 11]
T1≦H1≦5×T1 [Conditional Equation 12]
0.1×T1≦H2≦4×T1 [Conditional Equation 13]
0.3×T1≦H3≦4×T1 [Conditional Equation 14]
0.3×T1≦L1≦5×T1 [Conditional Equation 15]
0.1×T1≦R1≦T1 [Conditional Equation 16]
0.3×W3≦W5≦0.9×W3 [Conditional Equation 17]
0.3×H3≦H5≦0.9×H3 [Conditional Equation 18]
where T1 is a thickness of the base plate, W1 is a distance from an inner peripheral surface of the fixing part to an outer peripheral surface of the seating part, W2 is a distance from an outer peripheral surface of the fixing part to an inner peripheral surface of the seating part, W3 is a distance from the inner peripheral surface of the seating part to the outer peripheral surface of the seating part, H1 is a distance from a lower surface of the base plate to an upper surface of the seating part, H2 is a distance from the lower surface of the base plate to a lower surface of the extension part, H3 is a distance from an upper surface of the extension part to the upper surface of the seating part, L1 is a distance from the inner peripheral surface of the fixing part to the inner peripheral surface of the seating part, R1 is a radius of curvature of an inner side end of the extension part and an upper end of the seating part provided in a curved surface shape, W5 is a distance from an inner peripheral surface of the protrusion part to an outer peripheral surface thereof, and H5 is an axial length of the protrusion part.

11. The motor of claim 1, wherein the rotor is provided with a main wall part protruding from one surface thereof so as to face an inner peripheral surface of the seating part.

12. The motor of claim 11, wherein the main wall part has a stopper coupled to an inner peripheral surface thereof.

13. The motor of claim 12, wherein an upper portion of the sleeve is provided with a flange part protruding in the outer diameter direction.

14. The motor of claim 13, wherein a portion of an upper surface of the stopper faces a portion of a lower surface of the flange part.

15. The motor of claim 12, wherein an outer peripheral surface of the sleeve and an inner peripheral surface of the stopper include a sealing part formed therebetween in order to seal a lubricating fluid.

16. A motor comprising:
a sleeve rotatably supporting a shaft;
a base plate having the sleeve fixed thereto;
a stator coupled to the base plate and including a core having a coil wound therearound in order to generate rotational driving force; and
a rotor fixed to the shaft to be rotatable with respect to the stator and including a magnet facing the core, the base plate including a fixing part having the sleeve fixed thereto, an extension part extended from the fixing part in an outer diameter direction, a seating part having the stator seated thereon, a connection part connecting the extension part and the seating part to each other, and a body part extended from the seating part in the outer diameter direction.

17. The motor of claim 16, wherein the connection part has a flat upper surface.

18. The motor of claim 16, wherein an outer peripheral surface of the extension part and an inner peripheral surface of the seating part include a second space part provided therebetween.

19. The motor of claim 16, wherein an upper surface of the connection part has a curved shape.

20. The motor of claim 16, wherein an outer peripheral surface of the seating part is provided with a step part, and the core is seated on the step part.

21. The motor of claim 16, wherein the base plate is formed by press processing.

22. The motor of claim 16, wherein an outer peripheral surface of the fixing part and an inner peripheral surface of the seating part include a first space part provided therebetween.

23. The motor of claim 22, wherein an outer peripheral surface of the extension part and the inner peripheral surface of the seating part include a second space part provided therebetween.

24. The motor of claim 16, wherein the rotor is provided with a main wall part protruding from one surface thereof.

25. The motor of claim 24, wherein the main wall part has a stopper coupled to an inner peripheral surface thereof.

26. The motor of claim 25, wherein an upper portion of the sleeve is provided with a flange part protruding in the outer diameter direction.

27. The motor of claim 25, wherein an outer peripheral surface of the sleeve and an inner peripheral surface of the stopper include a sealing part formed therebetween in order to seal a lubricating fluid.

28. The motor of claim 16, wherein the motor is provided to satisfy the following Conditional Equations 19 to 28:
T1≦W1≦5×T1 [Conditional Equation 19]
0.1×T1≦W2≦4×T1 [Conditional Equation 20]
0.3×T1≦W3≦4×T1 [Conditional Equation 21]
T1≦H1≦5×T1 [Conditional Equation 22]
0.1×T1≦H2≦4×T1 [Conditional Equation 23]
0.3×T1≦H3≦4×T1 [Conditional Equation 24]
0.3×T1≦L1≦5×T1 [Conditional Equation 25]
0.1×T1≦R1≦T1 [Conditional Equation 26]
0.1×T1≦W4≦3×T1 [Conditional Equation 27]
0.1×T1≦H4≦4×T1 [Conditional Equation 28]
where T1 is a thickness of the base plate, W1 is a distance from an inner peripheral surface of the fixing part to an outer peripheral surface of the seating part, W2 is a distance from an outer peripheral surface of the fixing part to an inner peripheral surface of the seating part, W3 is a distance from the inner peripheral surface of the seating part to the outer peripheral surface of the seating part, H1 is a distance from a lower surface of the base plate to an upper surface of the seating part, H2 is a distance from the lower surface of the base plate to a lower surface of the extension part, H3 is a distance from an upper surface of the extension part to the upper surface of the seating part, L1 is a distance from the inner peripheral surface of the fixing part to the inner peripheral surface of the seating part, R1 is a radius of curvature of an inner side end of the extension part and an upper end of the seating part provided in a curved surface shape, W4 is a distance from an outer peripheral surface of the extension part to the inner peripheral surface of the seating part, and H4 is a distance from the lower surface of the extension part to the upper surface thereof.
